(19) United States
(12) Patent Application Publication
(10) Pub. No.: US 2019/0071591 A1
(43) Pub. Date: Mar. 7, 2019

(54) PATTERNED ADHESIVES AND LAMINATE CONSTRUCTIONS WITH PATTERNED ADHESIVES

(71) Applicant: Avery Dennison Corporation, Glendale, CA (US)

(72) Inventors: Michael RAMSAY, Newbury, OH (US); Thomas J. PAQUIN, Perry, OH (US); Steven REEKMANS, Leuven (BE)

(21) Appl. No.: 16/121,465

(22) Filed: Sep. 4, 2018

Related U.S. Application Data
(60) Provisional application No. 62/554,235, filed on Sep. 5, 2017.

(51) Int. Cl. C09J 7/40; C09J 7/38; C09J 7/21; C09J 7/22

(52) U.S. Cl. CPC C09J 7/403; C09J 7/38; C09J 7/401; C09J 7/405; C09J 7/21; C09J 7/22; C09J 2433/006; C09J 2400/283; C09J 2423/006; C09J 2423/046; C09J 2423/106; C09J 2467/006; C09J 2475/006; C09J 2483/005

(57) ABSTRACT

Laminates having channels along their adhesive face are described. The channels are formed in Voronoi patterns to promote air egress and reduce “pattern show-through.” The laminates include one or more substrate(s), an adhesive layer having the channels, and an optional release liner in contact with the adhesive layer.

### CROSS-REFERENCE TO RELATED APPLICATION

The present application claims the benefit of U.S. Provisional Patent Application No. 62/554,235 filed Sep. 5, 2017, which is incorporated herein by reference in its entirety.

### FIELD

The present subject matter relates to patterned adhesives used in labels and other laminate assemblies, including graphics laminate constructions, which exhibit reduced pattern perceptibility or “show-through.”

### BACKGROUND

Labels and laminate assemblies such as graphic films, packaging and other film or paper-based layered materials typically include one or more regions of adhesive for adhering the label or laminate to a surface of interest. For many applications, it is desirable that the adhesive region(s) underlying an outermost layer of the label or laminate not be visible.

In some applications in which an adhesive-backed sheet is applied to a surface, when air bubbles become entrapped between the sheet and surface, the outer surface of the sheet may exhibit a textured or uneven appearance, which in most applications is undesirable. Thus, artisans have incorporated channels within the adhesive layer to promote escape of air or other fluids along the interface of the sheet and surface, particularly during application of the sheet to the surface.

Although satisfactory in many respects, in certain labels or laminates with adhesive patterns having channels, such patterns may be perceptible along an outer surface of the label or laminate. This is often referred to as “show-through” or “telegraphing.” Accordingly, a need exists for a strategy for reducing “show-through” in labels and laminates.

### SUMMARY

The difficulties and drawbacks associated with previous approaches are addressed in the present subject matter as follows.

In one aspect, the present subject matter provides a laminate comprising a substrate defining a first outermost surface and an oppositely directed inner surface. The laminate also comprises an adhesive layer disposed proximate the inner surface of the substrate. The adhesive layer defines an oppositely directed adhesive face. The adhesive face defines a plurality of channels in the form of a Voronoi pattern.

In another aspect, the present subject matter provides a method for making a laminate construction. The method comprises embossing a release liner with a form face having channels in the form of a Voronoi pattern. The release liner has a first, release system coated face and a second face. The method also comprises coating an adhesive onto the release system coated face. And, the method comprises laminating a substrate onto the adhesive coated release liner.

In yet another aspect, the present subject matter provides a method of forming an adhesive laminate which exhibits reduced pattern show-through after application to a surface of interest. The method comprises providing a substrate defining a first surface and an oppositely directed second surface. The method also comprises applying adhesive to the second surface to thereby form an adhesive layer having an adhesive face. And, the method comprises forming air egress channels in the form of a Voronoi pattern in the adhesive face.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional view of a laminate in accordance with an embodiment of the present subject matter.

FIG. 2 is an example of a Voronoi pattern utilized in the present subject matter.

FIG. 3 is a detailed view of a portion of the Voronoi pattern illustrated in FIG. 2.

FIG. 4 is a schematic cross sectional view of a release liner being embossed by a textured roller in accordance with an embodiment of the present subject matter.

FIG. 5 is a schematic cross sectional view of the embossed release liner of FIG. 4 with an adhesive layer disposed thereon.

FIG. 6 is a schematic cross sectional view of the embossed release liner and adhesive layer of FIG. 5 with a substrate disposed thereon.

FIG. 7 is a schematic cross sectional view of an adhesive and a substrate prior to embossing in an embodiment of the present subject matter.

FIG. 8 is a schematic cross sectional view of an operation in which a Voronoi pattern is formed in the adhesive layer of the assembly shown in FIG. 7.

FIG. 9 is a schematic cross sectional view of another operation in which a Voronoi pattern is formed in the adhesive layer of the assembly shown in FIG. 7.

FIG. 10 is a schematic cross sectional view of an adhesive layer having a plurality of non-adhesive forms in a Voronoi pattern in an embodiment of the present subject matter.

FIG. 11 is a schematic cross sectional view of a release layer having a plurality of non-adhesive forms in a Voronoi pattern in an embodiment of the present subject matter.

### DETAILED DESCRIPTION OF THE EMBODIMENTS

The present subject matter provides a new class of labels and laminates and particularly adhesive-backed sheets which include air egress pattern(s) that result in reduced pattern show-through. The present subject matter also provides methods of reducing pattern show-through in labels and laminates and particularly adhesive-backed sheets by incorporation of the air egress patterns described herein. And, the present subject matter also provides methods of forming labels and laminates which exhibit reduced pattern show-through. These and other aspects of the present subject matter are described herein.

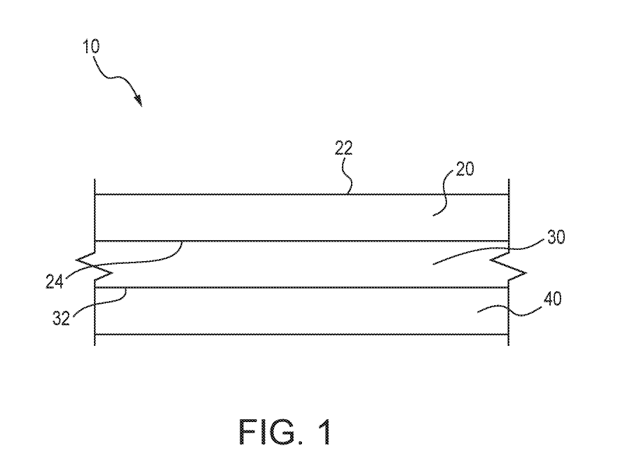

FIG. 1 is a schematic cross sectional view of an embodiment of a label or laminate 10 in accordance with the present subject matter. The laminate 10 comprises one or more substrate and/or support layers collectively shown as 20, one or more adhesive layers or regions 30, and an optional liner or protective layer 40 covering all or a portion of the adhesive layer 30. The substrate 20 defines an outermost surface or face 22 which upon application of the laminate 10 to a surface of interest, is visible to a user or the environment. The substrate 20 defines an oppositely directed inner face 24. Typically, the adhesive layer 30 is disposed proximate or immediately adjacent the inner surface or face 24 of the substrate 20. As will be appreciated, the laminate 10 is applied to a surface of interest by removing the optional liner 40 to expose an adhesive face 32 and subsequently contacting the adhesive face 32 with the surface of interest.

The present subject matter provides air egress channels along the adhesive face 32 that (i) promote egress or exiting of air during application of the laminate 10 to a surface of interest, and/or (ii) exhibit reduced show-through or perceptibility when viewing the laminate 10 along the outermost surface 22.

The air egress channels along the adhesive face are in the form of a Voronoi pattern, and in particular embodiments, a Voronoi pattern having certain characteristics. In accordance with the present subject matter, the use of Voronoi pattern air egress channels in the adhesive region(s) significantly reduces show-through. In addition, the use of Voronoi pattern air egress channels in the adhesive region(s) promotes air egress from the adhesive-surface interface in all directions regardless of the direction of application of the laminate to the surface.

### Voronoi Patterns

A Voronoi pattern or Voronoi diagram results from partitioning of a plane with n points into convex polygons such that each polygon contains exactly one generating point and every point in a given polygon is closer to its generating point than to any other generating point. Voronoi patterns find widespread applications in areas such as computer graphics, epidemiology, geophysics, and meteorology. A particularly notable use of a Voronoi diagram was the analysis of the 1854 cholera epidemic in London, in which physician John Snow determined a strong correlation of deaths with proximity to a particular (and infected) water pump on Broad Street.

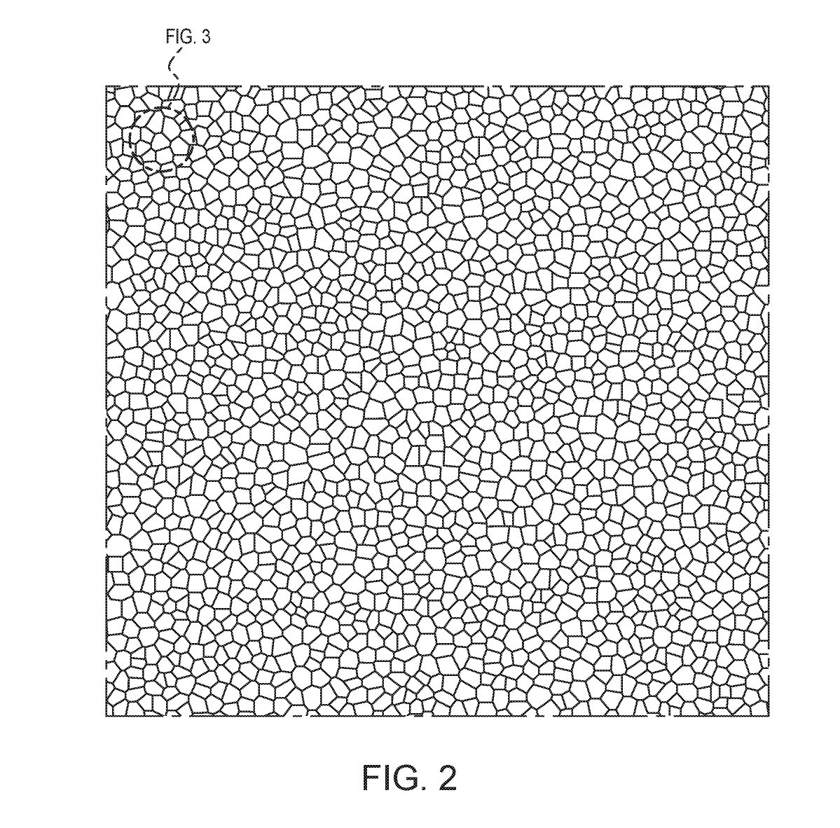

FIG. 2 is a representative Voronoi pattern based upon a plurality of n generating points and the convex polygons in which each polygon contains a single generating point.

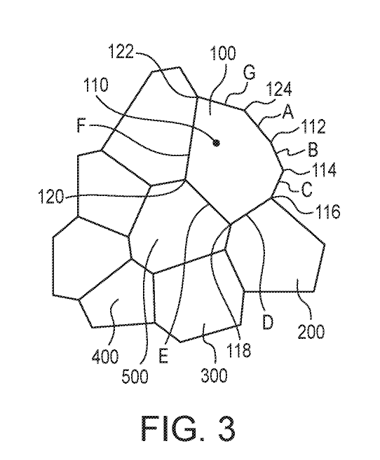

FIG. 3 is a detailed view of a portion of the representative Voronoi pattern depicted in FIG. 2 and incorporation of that pattern in an adhesive face such as adhesive face 32. FIG. 3 illustrates convex polygons 100, 200, 300, 400, and 500. Polygon 100 is defined by a generating point 110 and includes sides A, B, C, D, E, F, and G. Sides A and B intersect at corner 112. Sides B and C intersect at corner 114. Sides C and D intersect at corner 116. Sides D and E intersect at corner 118. Sides E and F intersect at corner 120. Sides F and G intersect at corner 122. And, sides G and A intersect at corner 124.

In particular embodiments of the present subject matter, air egress channels are formed along adhesive faces such as face 32 of a laminate, in which the air egress channels correspond to sides of polygons in the Voronoi pattern. In still further embodiments of the present subject matter, the Voronoi pattern air egress channels exhibit particular characteristics as follows. Each polygon in the Voronoi pattern air egress channels exhibits a maximum span which is within a range of from about 2 to about 5 times of a minimum span of that polygon. Referring to FIG. 3 and polygon 100 for example, the maximum span of polygon 100 is the maximum distance between any two corners of the polygon corners, i.e., corners 112, 114, 116, 118, 120, 122, and 124. The maximum span in this example is between corners 118 and 122. And, the minimum span of polygon 100 is the minimum distance between any two corners, i.e., corners 112, 114, 116, 118, 120, 122, and 124. The minimum span is between corners 112 and 114. It has been discovered in accordance with the present subject matter that reduced pattern show-through and/or improved air egress occurs for Voronoi pattern air egress channels in which the maximum span for any polygon in the Voronoi pattern air egress channels is within a range of from about 2 to about 5 times the minimum span of that polygon. This relationship is shown as Formula (I)

(2×Minimum Span)≤Maximum Span≤(5×Minimum Span) (I)

In many applications, a minimum span of any polygon of a Voronoi pattern air egress channel has a length of from about 10,000 microns to about 1,000 microns, and more particularly from about 7,500 microns to about 2,500 microns. Thus, as an example of the noted relationship between any polygon's minimum span and maximum span, if a minimum span of a polygon is 5,000 microns, then the maximum span of that polygon is within a range of from about 10,000 microns to about 25,000 microns.

### Laminates

The present subject matter includes a wide array of materials for the substrate(s) and other layers or components associated with the substrate. The substrate may be any of those which are useful for decorative or graphic image applications. The substrate typically has a thickness from about 10 to about 300, or from about 25 to about 125 microns. The substrate includes paper, polyolefins (linear or branched), polyamides, polystyrenes, nylon, polyesters, polyester copolymers, polyurethanes, polysulfones, polyvinylchloride, styrene-maleic anhydride copolymers, styrene-acrylonitrile copolymers, ionomers based on sodium or zinc salts of ethylene methacrylic acid, polymethyl methacrylates, cellulosics, fluoroplastics, acrylic polymers and copolymers, polycarbonates, polyacrylonitriles, and ethylene-vinyl acetate copolymers. Included in this group are acrylates such as ethylene methacrylic acid, ethylene methyl acrylate, ethylene acrylic acid and ethylene ethyl acrylate. In many embodiments, the substrate includes one or more polyolefin films.

The polyolefin film may comprise polymers and copolymers of monoolefins having from, for example, 2 to 12 carbon atoms, and preferably 2 to 8 carbon atoms. Most preferred are the polymers of α-olefins having from 2 to 4 carbon atoms per molecule. Examples of such homopolymers include polyethylene, polypropylene, poly-1-butene, etc. An example of a copolymer within the above definition is a copolymer of ethylene with 1-butene having from 1 to 10, preferably from 1 to 5 and more preferably from 1 to 3 weight percent of the 1-butene comonomer incorporated into the copolymer molecule. Blends of copolymers with polyisobutylene also are useful, and examples of such blends include those blends containing up to about 35 weight percent, preferably from 1 to 35 weight percent of polyisobutylene and from 99 to 65 weight percent of a copolymer of ethylene, another comonomer such as 1-butene.

The present subject matter includes a wide variety of adhesives and adhesive materials. In many embodiments, the adhesive is a pressure sensitive adhesive. Nearly any pressure-sensitive adhesive composition known in the art can be used in the laminates of the present subject matter. Such adhesive compositions are described in, for example, “Adhesion and Bonding,” Encyclopedia of Polymer Science and Engineering, Vol. 1, pp. 476-546, Interscience Publishers, Second Ed., 1985. Such compositions generally contain an adhesive polymer such as natural or reclaimed rubbers, styrene-butadiene rubber, styrene-butadiene or styrene-isoprene block copolymers, polyisobutylene, poly(vinylether) or poly(acrylic)ester as a major constituent. Other materials may be included in the pressure-sensitive adhesive composition such as resin tackifiers including rosin esters, oil-soluble phenolics and polyterpenes; antioxidants; plasticizers such as mineral oil or liquid polyisobutylene; and fillers such as zinc oxide or hydrated alumina. The selection of the pressure-sensitive adhesive to be used in any laminates of the present subject matter is not critical, and those skilled in the art are familiar with many suitable pressure-sensitive adhesives for particular applications.

The adhesive layer typically has a thickness from about 10 to about 125, or from about 25 to about 75, or from about 10 to about 50 microns. In one embodiment, the coat weight of the pressure sensitive adhesive is in the range of about 10 to about 50 grams per square meter (gsm), and in one embodiment about 20 to about 35 gsm.

The present subject matter also includes a wide array of liners or other protective layers for covering the adhesive face. Typically, the liner is coated with one or more release agents.

Release liners for use in the present subject matter may be those known in the art. In general, useful release liners include polyethylene coated papers with a commercial silicone release coating, polyethylene coated polyethylene terephthalate films with a commercial silicone release coating, or cast polypropylene films that can be embossed with a pattern or patterns while making such films, and thereafter coated with a commercial silicone release coating. A preferred release liner is kraft paper which has a coating of low density polyethylene on the front side with a silicone release coating and a coating of high density polyethylene on the back side. Other release liners known in the art are also suitable as long as they are selected for their release characteristics relative to the pressure sensitive adhesive chosen for use in the present subject matter.

As noted, the Voronoi pattern air egress channels formed in the adhesive layer and specifically, along the adhesive face of that layer correspond to the polygons and particularly the sides of polygons in the Voronoi pattern. Although not wishing to be limited to any particular dimensions, typical depths of the air egress channels as measured from the adhesive face, are within a range of from about 0.3 microns to about 100 microns, in certain embodiments from about 0.5 microns to about 50 microns, and in particular embodiments from about 2 microns to about 20 microns. It will be appreciated that the present subject matter includes channel depth(s) less than and/or greater than these representative depths. The width of the air egress channels may also vary. Typically, the width of the channels is within a range of from about 12 microns to about 250 microns. In certain embodiments, the width is from about 25 microns to about 125 microns. And, in particular embodiments, the width is from about 50 microns to about 75 microns. It will be understood that the present subject matter includes channel width(s) less than and/or greater than these representative values.

In certain embodiments, the Voronoi pattern air egress channels in the adhesive layer are formed by embossed patterns in a release liner or layer that is applied onto the adhesive layer. Upon removal of the release liner, the noted channels remain in the adhesive layer. A wide array of techniques can be used to form embossed patterns on the release liner which, upon application to and subsequent removal from, the adhesive layer; form the Voronoi pattern air egress channels in the adhesive layer. Additional details of the various representative techniques are provided herein.

### Methods

The present subject matter also provides methods of forming an adhesive laminate which exhibits reduced pattern show-through, typically after application to a surface of interest. The methods generally comprise providing one or more substrates and then applying adhesive to a face of the substrate to thereby form an adhesive layer having an exposed adhesive face. The methods also comprise forming a plurality of air egress channels in the form of a Voronoi pattern in the adhesive face. The resulting adhesive laminate exhibits reduced pattern show-through and/or improved air egress characteristics.

Various techniques can be used to form the plurality of air egress channels in the form of a Voronoi pattern in the adhesive face. In certain embodiments, an adhesive laminate is provided by forming the air egress channels into the adhesive face by contacting the adhesive face with a form face that defines a plurality of projections corresponding to air egress channels in the form of a Voronoi pattern as described herein. Contacting is performed typically in conjunction with pressure application to thereby form air egress channels in the adhesive face that correspond to the plurality of projections on the form face.

The form face can be a roller such as a flexographic printing roller, a stamp or molding surface, or other similar component. In certain embodiments, the form face is provided on a release liner that is applied to cover the adhesive face. The plurality of projections on the release liner can be integrally formed on or with the liner, or in particular embodiments are printed on a release face of the release liner. The resulting printed projections are in the form of a Voronoi pattern as described herein and upon application to the adhesive layer, form air egress channels in the adhesive layer.

In a particular embodiment of the present subject matter, a release face of a release liner is embossed with a textured or patterned embossing roll. The release liner is supported during this operation by a flat back-up roll. The use of a single textured embossing roll and a flat back-up roll has been discovered to provide advantages in producing the patterned laminates described herein. Furthermore, the use of a combination of a single textured embossing roll and a flat back-up roll has been found to be preferred for many applications as compared to the use of two patterned embossing rolls. A textured embossing roll having a Voronoi pattern as described herein, is contacted and applied across a release face of a release liner. The release liner is supported by a flat back-up roller along an opposite face of the release liner. Upon application of pressure and optional heating of the textured embossing roller and/or the back-up roller, the Voronoi pattern is formed in the release face. The Voronoi pattern air egress channels in the adhesive layer are formed by contacting the embossed release face of the release liner to the adhesive face, and applying pressure thereto. Upon subsequent removal of the release liner from the adhesive face, the noted air egress channels are formed in the adhesive layer.

The present subject matter also includes the use of non-adhesive forms that are applied to either or both of the release face and/or the adhesive face. In certain embodiments non-adhesive forms are in Voronoi patterns as described herein, and provide the air egress channels in the adhesive layer. The present subject matter also includes the use of non-adhesive forms that are arranged in patterns or configurations different than a Voronoi pattern. These aspects are described in greater detail herein. The non-adhesive forms can be applied by printing non-adhesive materials such as inks for example onto either or both of the release face and/or the adhesive face. The present subject matter also includes techniques in which moldable or shapeable materials are applied onto either or both of the release face and/or the adhesive face. The present subject matter additionally includes techniques in which materials are embedded in either or both of the release face and/or the adhesive face.

In a particular embodiment, non-adhesive forms are printed, embedded, and/or molded into or onto a release face of a release liner. The non-adhesive forms are applied or formed in a Voronoi pattern as described herein. The material of the non-adhesive forms is a non-adhesive material and may for example be a printing ink. However, the present subject matter includes a wide array of other materials for use as the non-adhesive forms. The release liner having the Voronoi patterned non-adhesive forms is contacted with the adhesive face. Upon removal of the release liner from the adhesive face, air egress channels are formed in the adhesive face. In certain versions of the techniques, the non-adhesive forms remain with the adhesive face. Typically, the non-adhesive forms extend or project outwardly beyond the adhesive face so as to create the air egress channels as described herein. In these techniques, the adhesive force between the adhesive layer and the non-adhesive forms is greater than the adhesive force between the non-adhesive forms and the release face of the release liner.

As noted, in certain embodiments non-adhesive forms can be used in addition to the Voronoi patterns of the present subject matter. For example, non-adhesive forms can be randomly distributed on an adhesive face, wherein the adhesive face includes channels in the form of Voronoi pattern(s). Such Voronoi pattern(s) can be formed in the adhesive face by a variety of techniques such as by embossing as described herein. The non-adhesive forms on the adhesive face may impart additional functionality and/or may further promote air egress.

Additional details of forming air egress provisions are described in U.S. Pat. Nos. 7,332,205 and 6,630,049.

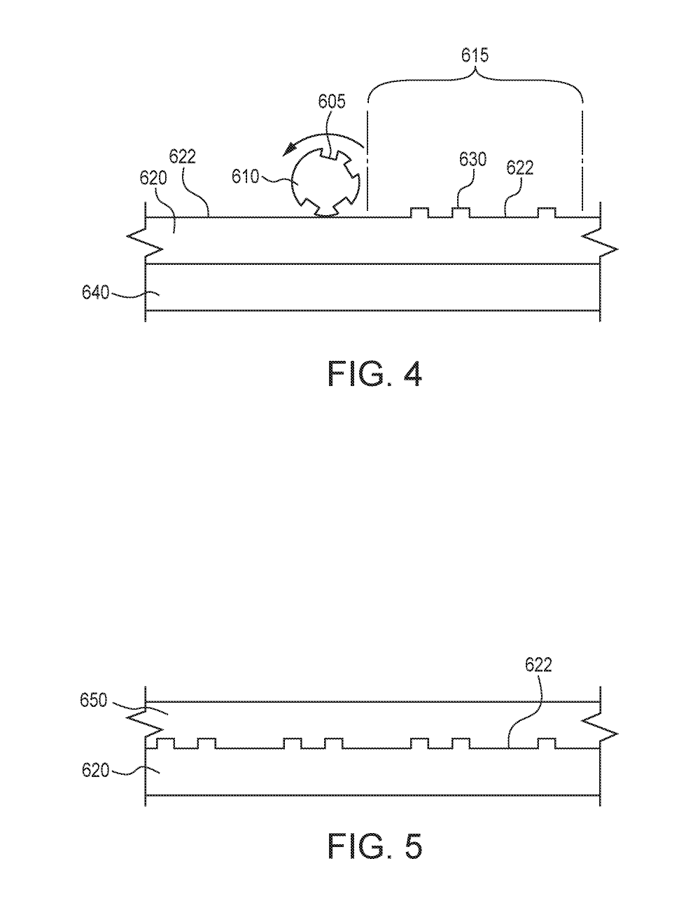

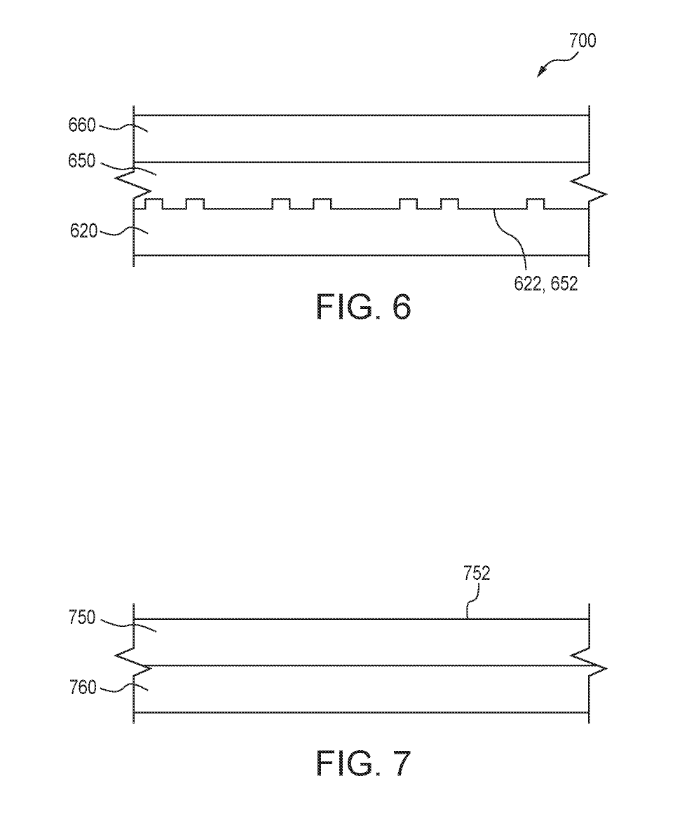

FIG. 4 is a schematic diagram illustrating a process for embossing a release liner 620 having a release face or a release system coated face, in the form of a Voronoi pattern 615. The release liner 620 includes a release face 622 in which a plurality of air egress channels 630 are formed in a Voronoi pattern 615 as described herein, using a textured or embossed roller 610. The textured roller 610 includes a plurality of recessed regions 605 extending from the roller which are also in a Voronoi pattern. The textured roller could include projections instead of all or a portion of the noted recessed regions. The pattern formed on the release face 622 is a negative or inverse configuration of the desired Voronoi pattern to be formed in the adhesive face. Thus, the pattern on the textured roller 610 is in the desired Voronoi pattern to be formed in the adhesive face. The process 600 may optionally include the use of a flat back-up roller 640 for supporting the release liner 620. After forming the embossed release liner 620 of FIG. 4, an adhesive can be coated on the embossed face 622 of the release liner 620 to form an adhesive layer 650 as shown in FIG. 5. A substrate 660 can be laminated onto the resulting adhesive layer 650 to form a laminate 700 as shown in FIG. 6. Prior to use of the laminate 700, the release liner 620 is then removed from the adhesive layer 650. In this embodiment, the adhesive force between the adhesive 650 and the substrate 660 is greater than the adhesive force between the adhesive 650 and the release liner 620. The exposed adhesive face 652 exhibits a series or plurality of air egress channels in the form of a Voronoi pattern which is the negative or inverse of the Voronoi pattern 615 in the release liner 620.

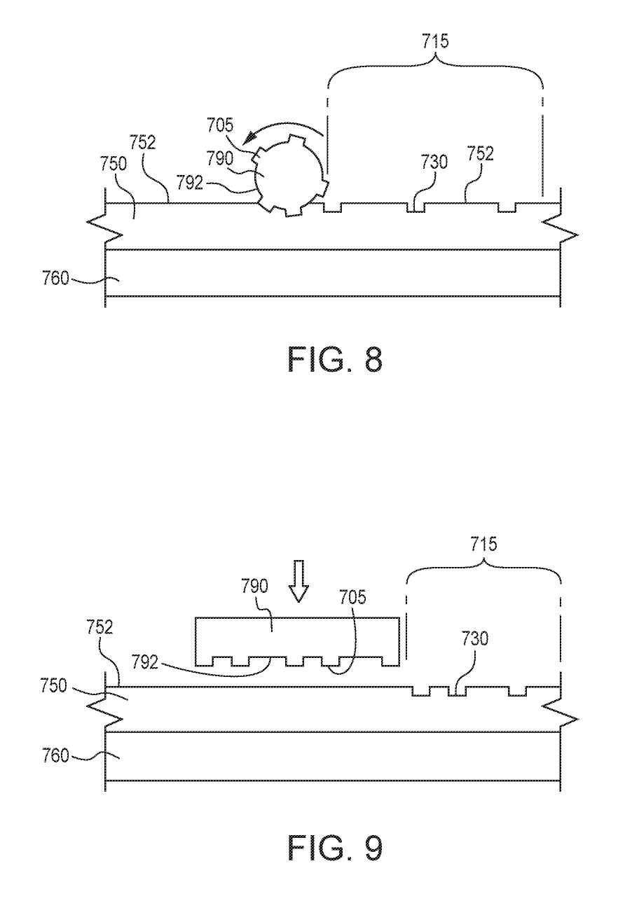

In another embodiment depicted in FIG. 7, the present subject matter provides a method in which a substrate 760 is provided having an adhesive layer 750 disposed thereon. The adhesive layer 750 defines an adhesive face 752. Air egress channels 730 in the form of a Voronoi pattern 715 are formed in the adhesive face 752 as shown in FIG. 8 or 9. A form 790 is provided that includes a form face 792 with a plurality of projections 705 which correspond to the air egress channels in the Voronoi pattern 715. As will be appreciated, the pattern on the form face 792 is a negative or inverse configuration of the desired Voronoi pattern to be formed in the adhesive face 752. The form face 792 is contacted with the adhesive face 752 such that the plurality of projections 705 form a plurality of air egress channels 730 in the form of the Voronoi pattern 715 along the adhesive face 752. The form 790 can be cylindrical as depicted in FIG. 8 or a non-cylindrical or flat form as shown in FIG. 9.

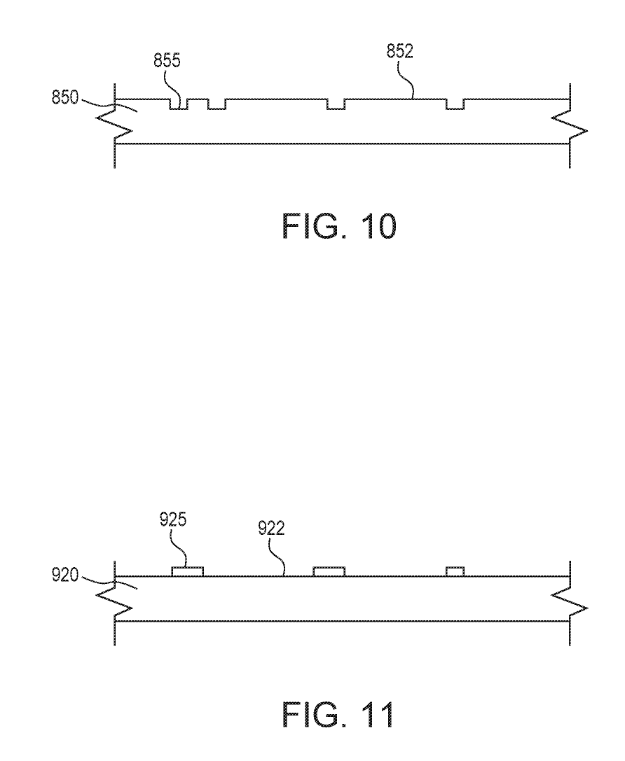

FIGS. 10 and 11 schematically depict additional aspects of the present subject matter. FIG. 10 shows an adhesive layer 850 defining an adhesive face 852 with a plurality of non-adhesive forms 855 disposed on the face 852. The non-adhesive forms 855 are arranged in a Voronoi pattern as described herein. FIG. 11 shows a release liner 920 defining a release face 922 with a plurality of non-adhesive forms 925 disposed on the face 922. The non-adhesive forms 925 are arranged in a negative or inverse configuration of the desired Voronoi pattern as described herein.

It will be understood that the present subject matter includes a wide array of techniques and strategies for forming the noted channels in an adhesive face in the form of a Voronoi pattern. The channels can be formed directly in the adhesive face by embossing or urging a form face having projections which are in a negative or inverse configuration of the desired Voronoi pattern. The channels can be formed by depositing or otherwise applying non-adhesive forms on either the adhesive face or on an embossing or form face. The non-adhesive forms if applied directly to the adhesive face form the noted channels between the non-adhesive forms. The non-adhesive forms if applied to an embossing or form face constitute projections that in turn form the channels in the adhesive face, and so the non-adhesive forms are arranged in a negative or inverse configuration of the desired Voronoi pattern.

The present subject matter also provides methods of reducing adhesive pattern show-through of a laminate. The methods comprise providing an adhesive laminate that includes one or more substrates and an adhesive layer that defines an adhesive face. The methods additionally comprise forming a plurality of air egress channels on or in the adhesive face in which the air egress channels are in the form of a Voronoi pattern as described herein.

Although the present subject matter has been described in terms of channels, recesses, or depressions that are formed or otherwise provided along an adhesive face in the form of a Voronoi pattern, it will be understood that the present subject matter includes projections or other topological structures that extend outward from the adhesive face in the form of a Voronoi pattern.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A laminate comprising:
a substrate defining a first outermost surface and an oppositely directed inner surface;
an adhesive layer disposed proximate the inner surface of the substrate, the adhesive layer defining an oppositely directed adhesive face;
wherein the adhesive face defines a plurality of channels in the form of a Voronoi pattern.

2. The laminate of claim 1 wherein the channels in the form of a Voronoi pattern include a plurality of polygons.

3. The laminate of claim 2 wherein the polygons are convex polygons.

4. The laminate of claim 2 wherein each polygon of the plurality of polygons defines a maximum span and a minimum span wherein the maximum span is within a range of from 2 times the minimum span to 5 times the minimum span.

5. The laminate of claim 1 wherein the adhesive layer includes a pressure sensitive adhesive.

6. The laminate of claim 1 further comprising:
a release liner having a first, release system coated face and a second face, the release system coated face in contact with the adhesive layer.

7. The laminate of claim 6, wherein the release system is a silicone-based release system.

8. The laminate of claim 1, wherein the substrate is selected from the group consisting of polymeric film and paper.

9. The laminate of claim 8, wherein the polymeric film is selected from the group consisting of vinyl, polyethylene, polypropylene, polyester, polyurethane, acrylics, and combinations thereof.

10. The laminate of claim 1, wherein the channels have a depth of about 0.3 microns to about 100 microns.

11. The laminate of claim 1, wherein the channels have a width of about 12 microns to about 250 microns.

12. The laminate of claim 1 further comprising a pattern of non-adhesive forms adhered to or embedded in the adhesive face.

13. The laminate of claim 12, wherein the pattern of non-adhesive forms comprises a plurality of dots, lines, or combinations thereof.

14. The laminate of claim 12, wherein the pattern is irregular.

15. A method for making a laminate construction, the method comprising:
embossing a release liner with a form face having channels in the form of a Voronoi pattern, the release liner having a first, release system coated face and a second face;
coating an adhesive onto the release system coated face; and
laminating a substrate onto the adhesive coated release liner.

16. The method of claim 15 wherein the channels in the form of a Voronoi pattern include a plurality of polygons.

17. The method of claim 16 wherein the polygons are convex polygons.

18. The method of claim 16 wherein each polygon of the plurality of polygons defines a maximum span and a minimum span, wherein the maximum span is within a range of from 2 times the minimum span to 5 times the minimum span.

19. The method of claim 15, wherein the adhesive is a pressure sensitive adhesive.

20. The method of claim 15, wherein the release system is a silicone-based release system.

21. The method of claim 15, wherein the substrate is selected from the group consisting of polymeric film and paper.

22. The method of claim 21, wherein the polymeric film is selected from the group consisting of vinyl, polyethylene, polypropylene, polyester, polyurethane, acrylics, and combinations thereof.

23. The method of claim 15, wherein the channels have a depth of about 0.3 microns to about 100 microns

24. The method of claim 15, wherein the channels have a width of about 12 microns to about 250 microns.

25. The method of claim 15, wherein the adhesive force between the adhesive and the substrate is greater than the adhesive force between the adhesive and the release liner.

26. The method of claim 25, wherein the adhesive exhibits a series of channels in the form of a Voronoi pattern which is the negative of the Voronoi pattern in the release liner.

27. The method of claim 15 wherein the release liner includes a plurality of non-adhesive forms.

28. The method of claim 27, wherein the adhesive force between the adhesive layer and the non-adhesive forms is greater than the adhesive force between the non-adhesive forms and the release system on the release liner.

29. A method of forming an adhesive laminate which exhibits reduced pattern show-through after application to a surface of interest, the method comprising:
providing a substrate defining a first surface and an oppositely directed second surface;
applying adhesive to the second surface to thereby form an adhesive layer having an adhesive face;
forming air egress channels in the form of a Voronoi pattern in the adhesive face.

30. The method of claim 29 wherein the forming air egress channels in the form of a Voronoi pattern in the adhesive face is performed by:
providing a form including a form face that defines a plurality of projections corresponding to air egress channels in the form of a Voronoi pattern;
contacting the form face of the form with the adhesive face such that the plurality of projections form a plurality of air egress channels in the form of a Voronoi pattern along the adhesive face, to thereby form the adhesive laminate which exhibits reduced pattern show-through.

31. The method of claim 30 wherein the plurality of projections on the form face correspond to the air egress channels in the form of a Voronoi pattern and include a plurality of polygons.

32. The method of claim 31 wherein the polygons are convex polygons.

33. The method of claim 31 wherein each polygon of the plurality of polygons defines a maximum span and a minimum span wherein the maximum span is within a range of from 2 times the minimum span to 5 times the minimum span.

34. The method of claim 30 wherein the form is selected from the group consisting of a roller, a stamp, and a molding surface.

35. The method of claim 30 wherein the form is a release liner.
